(19) United States
(12) Patent Application Publication
(10) Pub. No.: US 2016/0165044 A1
(43) Pub. Date: Jun. 9, 2016

(54) SYSTEM AND METHOD FOR CALL AUTHENTICATION

(71) Applicant: Stephanie Yinman Chan, Saratoga, CA (US)

(72) Inventor: Stephanie Yinman Chan, Saratoga, CA (US)

(21) Appl. No.: 14/562,510

(22) Filed: Dec. 5, 2014

(51) Int. Cl. H04M 3/42; H04W 4/12; H04M 3/53; H04W 4/16; H04M 3/22

(52) U.S. Cl. CPC H04M 3/42221; H04W 4/16; H04M 3/42059; H04M 3/42102; H04M 3/2218; H04M 3/5307; H04W 4/12

(57) ABSTRACT

A system and method of authenticating voice calls by recording the call and generating a transcript of the recorded call. The invention includes a recording unit configured to record audio communications taking place on a communications device, and storing the recorded call as an audio file. A transcription unit is configured to retrieve the audio file and convert it into a transcript that identifies each call participant and their associated dialogue in the correct sequence. Furthermore, the method includes contacting a third party service to initiate an authenticated call in which called parties are verified, and the call is recorded and transcribed.

### FIELD OF THE INVENTION

The present invention generally relates to systems and methods for recording voice communications and generating a transcript of the recording.

### BACKGROUND OF THE INVENTION

Voice communications have advanced tremendously since the advent of the telephone. Modern voice communication technologies include cell phone communications, wired phone communications, wireless communications, radio transceiver communications, and voice over Internet Protocol (VOIP). However, one of the disadvantages of voice communications is the lack of a verifiable written record of the conversation for later reference, such as for the use in legal proceedings. For example, a brainstorming session conducted over the phone would be much more valuable if the participants could record their conversation and have a written transcript of the conversation provided to them for later reference. Similarly, job candidates and interviewers conducting phone interviews could benefit from having their conversation recorded and being able to refer to a written record of their conversation. In the realm of legal affairs, a certified transcript of a recorded voice conversation could be very helpful in proving not only that a conversation occurred, but also the contents of the conversation.

Voice mail to text and voice recognition software are well known technologies, but there is a need for a system and method that records real time conversations on one or more communications devices and generates a transcript of the conversation. Further, there is a need for a means of verifying and certifying the transcribed conversation, so that the transcript can be accepted as an accurate, reliable record of the conversation that transpired at a particular date and time. Such a system should allow a user to instantly record their voice communications using hardware and/or software installed on a communications device and taking place over a variety of mediums, such as wired, wireless, over-the-air, and VOIP, and also generate a transcript of the recording. In addition, there is a need for a way to validate that a voice conversation conducted electronically (phone, voip, etc.) between two or more parties occurred. Call (phone) records are available to show that a party contacted another party at a specific date and over specific times, but documentation identifying the exact party names (individuals) does not exist. In addition, transcripts of phone conversations and/or voicemails do not verify the identities of actual parties involved in a conversations. There is therefore a need for a system and method of verifying the identities of parties to a voice call, and generating a certified, date stamped record of the conversation for use in official and legal proceedings.

### SUMMARY OF THE INVENTION

The present invention generally relates to recording audio or voice communications and generating a transcript of the recording.

According to an embodiment of the present invention, a system is provided for recording and transcribing a voice call. The system includes a recording unit configured to record audio communications in real time between two or more voice call participants, where the audio communications take place using one or more communications devices. Communications devices may include cell phones, wired phones, wireless devices, and VOIP enabled devices, where the recording unit is installed inside a communications device, or a remote computer that facilitates communications between communications devices. Furthermore, the communications device may include functionality for selectively recording a call and generating a transcript of the recording.

A recording may be initiated in several ways. For example, a user may select one or more designated keys on their communications device to activate the recording unit. Alternatively, the user may issue a voice command to start recording, or enter a code. Furthermore, a touch screen option to record a call may be provided. In another embodiment, a user contacts a third-party service to set up a recorded call. In this embodiment, the third-party service sets up a conference call between all the participants and notifies the participants that the call will be recorded. Once the participants consent to the recording, the recording is initiated. Once the call is ended the third-party service generates a transcript of the recording for distribution to one or more recipients. The third-party service may employ any or all of the system and methods described herein to record and transcribe the call.

Once a recording is initiated, an indicator may be used to indicate that a recording is in progress. For example, a flashing light, solid light, or an icon may be used to indicate that a recording is in progress. The recorded audio is saved in a digital audio file stored in a data store in the communications device used to place the call, or on a remotely linked storage device.

According to an embodiment of the present invention, the system further includes a transcription unit for retrieving the audio file and converting the file into a text file, such as a transcript, where each speaker is identified next to their associated audio speech and positioned in the correct sequence. In one embodiment, the transcription unit includes a speech recognition engine for recognizing different speakers and converting their audio dialogue to text. The text is stored as a text file.

According to an embodiment of the present invention, the system includes a transmission unit for transmitting the transcript to one or more recipients. In an alternate embodiment, the transcript is stored in a data store and secure access is provided to selected recipients.

According to an embodiment of the present invention, a voice call may be selectively recorded by one of the participants to the call and a transcript of the recording generated for distribution to one or more recipients.

According to another embodiment of the present invention, a computer program is provided that is configured to initiate a call and control a recording device that records the call. Once the recording is completed, the program provides a user with options to play back the recorded call, fast forward, rewind, and pause. In addition, the program provides an option to generate a written transcript of the call for distribution to one or more selected recipients.

According to an embodiment of the present invention, a method is provided for allowing a caller to use a third-party call authentication service that sets up and/or hosts the call between two or more participants. The participants may be notified that the call will be recorded, so that each participant can provide their expressed or implied consent to the recording. The third-party service then records and/or generates a certified, date stamped transcript of the call. The transcript can then be provided to one or more selected recipients.

In a further aspect of the invention, the third-party identifies call participants before setting up a recorded voice call by querying the user that initiated (i.e. call initiator). All call participants are then verified by the third party. Once the call participants are verified, the system connects the parties, records and/or transcribes the call, and generates both an audio file and a transcription file. Users can search these files using keywords or other database search tools and can elect to receive a certified date stamped copy of the transcript.

According to another embodiment, the system may also include dedicated inbound calls. In this embodiment, all of a user's calls are filtered through a third-party authentication service that records, transcribes and verifies every call. Alternatively, a main number is provided that a user can call and be routed to a party or phone number through the third party system, which records, transcribes and verifies the call. In this embodiment, the third party provider functions much like a directory in which a user can enter the first 3 digits of a person's last name to be connected to that person. In addition, the user could also be asked to provide a PIN or press “0” to be connected to a live person to route the call through the system.

According to an embodiment of the invention, a computer program is provided that is configured to initiate a call and control a recording unit that records the call. More specifically, the program controls a switch that activates/deactivates the recording device. In this aspect of the invention, the program activates the recording unit when a user selects a record option using a program interface. The user can optionally stop and restart the recording of the call at any time during the call using the program interface. Once the recording is completed, the recorded call is saved as an audio file. A call transcription module optionally transcribes the recording into a text file or transcript.

Once the audio file and transcript are generated, the program interface provides a user with options for manipulating the audio file. These options include, but are not limited to, (1) listening to the recording; (2) adding audio notes to the recording; (3) displaying the text transcript; (4) playing the audio file; (5) downloading the text transcript with or without a company certification stamp; (6) transmitting the text transcript to one or more selected recipients; and (7) submitting the audio file to a third party service for review to create a certified transcript that can be downloaded, emailed, or otherwise transmitted to selected recipients.

### BRIEF DESCRIPTION OF THE DRAWINGS

FIG. 1 illustrates an exemplary environment for practicing the invention;

FIG. 2 is a schematic diagram illustrating components and functions of the invention in accordance with an embodiment of the present invention;

FIG. 3 is a schematic diagram illustrating components and functions of the invention in accordance with another embodiment of the present invention;

FIG. 4 is a block diagram illustrating a process for practicing an aspect according to an embodiment of the present invention.

FIG. 5 is a flow chart illustrating a call authentication process according to an embodiment of the present invention.

FIG. 6 is a flow chart illustrating a call authentication process according to another embodiment of the present invention.

### DETAILED SPECIFICATION

The present invention generally relates to recording voice calls and generating a time stamped transcript of the recorded call.

Embodiments of the methods and systems are described below with reference to block diagrams and flow-chart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a computer, or other programmable data processing apparatus to produce a special purpose machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flow-chart illustrations, and combinations of blocks in the block diagrams and flowchart illustrations, can be implemented by special purpose hardware-based computer systems that perform the specified functions or steps, or combinations of special purpose hardware and computer instructions.

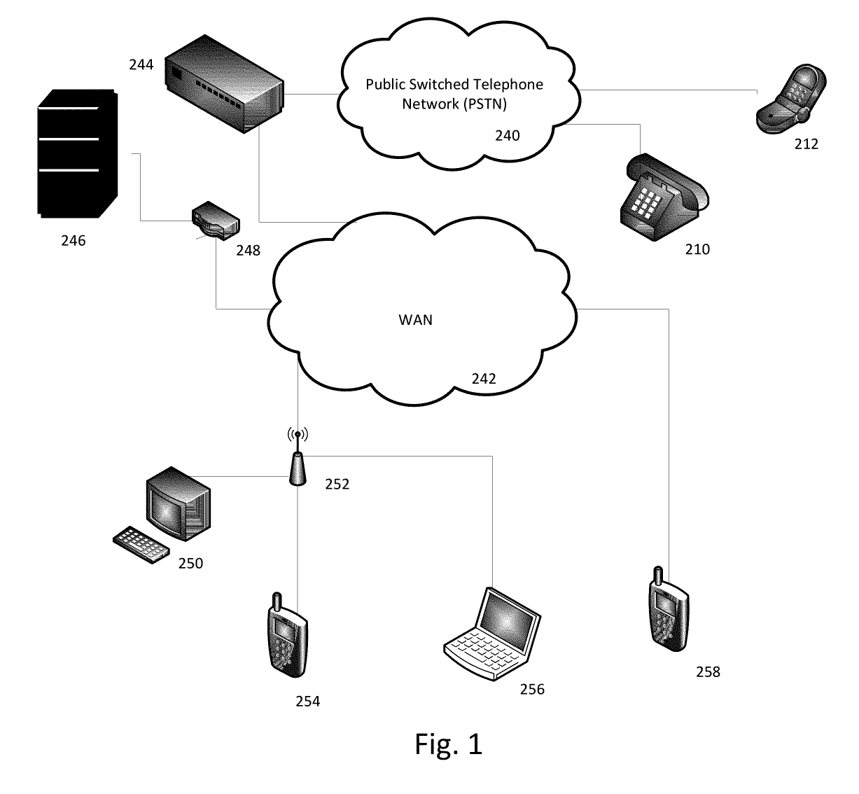

FIG. 1 illustrates an exemplary environment for practicing embodiments of the invention. As shown in FIG. 1, communications devices 210, 212, 254, 258 interface via a communications network, such as WAN 242 (e.g. the Internet) or a Public Switched Telephone Network (PSTN) 240. As shown in FIG. 1, communications devices 210, 212, 254, 258 are in numerous forms and versions, including wired and wireless as well as Internet-based devices such as a “soft-phone” and/or Internet messaging clients such as computers configured to use VoiP via tools like GoogleTalk™ and Skype™.

Audio voice connections can be, for example, conventional telephone connections (established by participants dialing a phone number to connect to a communications network, or by a third-party service dialing each of the participants. The audio connections can also be, for example, Voice-over-IP or some similar network connection. Some systems, such as the embodiment shown in FIG. 1, can support a mix of telephony and VoiP participants in any given call.

Applications in server 246 may also be used to manipulate information stored remotely and process and analyze data stored remotely across a WAN 242 (e.g., the Internet). As shown in FIG. 1, exchange of information through the WAN 242 or other network may occur through one or more high speed connections. In some cases, high speed connections may be over-the-air (OTA), passed through networked systems, directly connected to one or more WANs 242 or directed through one or more routers 248. Router(s) 248 are completely optional and other embodiments in accordance with the present invention may or may not utilize one or more routers 248. One of ordinary skill in the art would appreciate that there are numerous ways server 246 may connect to WAN 242 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 246 via WAN 242 or other network in numerous ways. For instance, a component may connect to the system i) through a computing device apparatus directly connected to the WAN (or via a wireless connection means such as CDMA, GSM, 3G, or 4G) 258 ii) through a computing device 250, 254, 256, connected to a wireless access point 252 or iii) through a communications device, 210, 212 via a wired or wireless connection (e.g., CDMA, GMS, 3G, 4G) to WAN 242 via the PSTN 240 and bridge 244. One of ordinary skill in the art would appreciate that there are numerous ways that a component may connect to server 246 via WAN 242 or other network, and embodiments of the present invention are contemplated for use with any method for connecting to server 246 via WAN 242 or other network. Furthermore, server 246 could be comprised of a personal computing device, such as a smartphone, acting as a host for other computing devices to connect to.

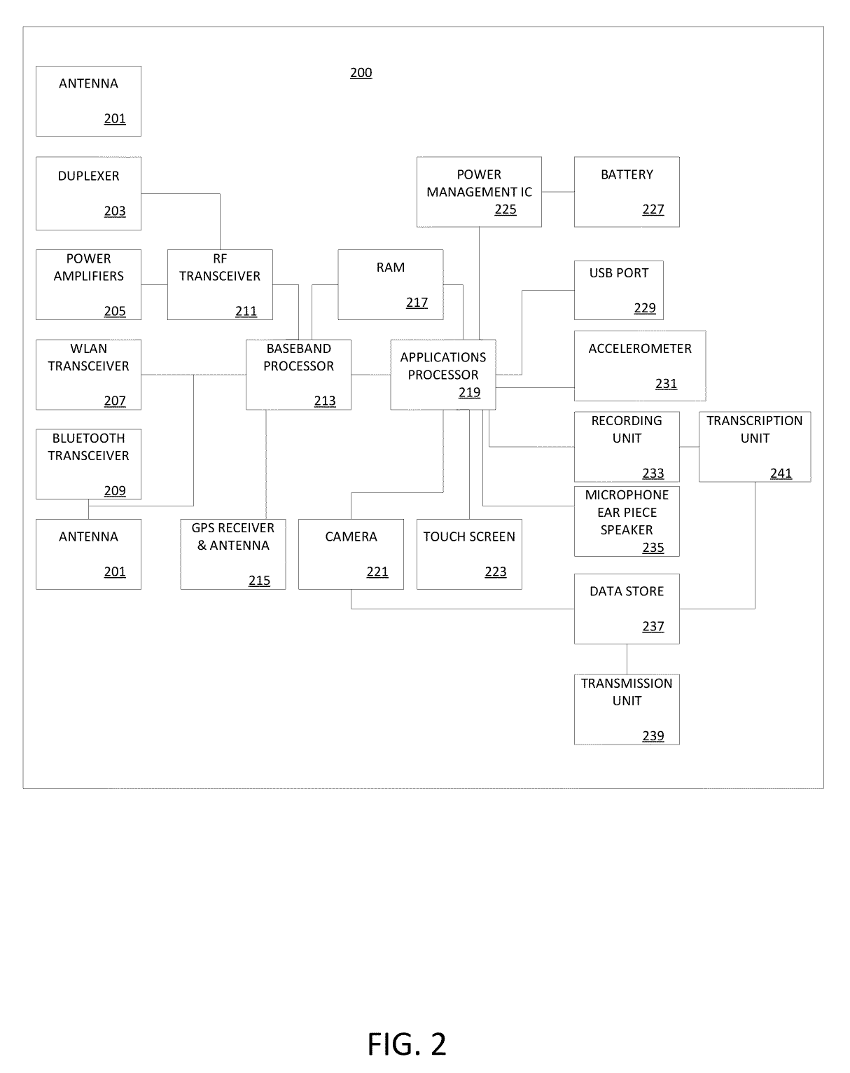

Embodiments described herein provide a practical way to record and transcribe a voice call and, as shown in FIG. 2, comprise a recording unit configured to detect and record audio communications in real time between two or more participants. The audio communications are facilitated by one or more communications devices connected to a communications network. The recording unit may include a voice activity detector (VAD) such as the VAD described in U.S. Pat. No. 5,255,340, incorporated herein by reference in its entirety. The recorded audio file may be stored as an audio file with date/time information.

FIG. 2 shows a layout of components in a wireless communications device. According to this embodiment, the systems and methods disclosed herein can be implemented via a wireless communications device in the form of a wireless phone. The components of the communications device 200 can comprise, but are not limited to, one or more processors 213 and 219 that can operate in parallel, a system memory 217, a duplexer 203, power amplifiers 205, one or more transceivers, such as WLAN transceiver 207, Bluetooth™ transceiver 209, and RF transceiver 211, and one or more antenna 201 and/or GPS receiver & antenna 215. In addition, the communications device may include camera 221, touch screen 223, a power management integrated circuit (IC), and battery 227. Other features include universal serial bus port (USB) 229, accelerometer 231, microphone ear piece speaker 235, and a data store 237.

As can be seen in FIG. 2, the communications device may include a recording unit 233 and transcription unit 241 in operable communication with each other and with applications processor 219. In this embodiment, the application processor may execute software applications associated with the recording unit and transcription unit, such as VAD software and automatic speech recognition (ASR) software. In addition, the recording unit 233 and Transcription Unit 241 may store and access files in data store 237, such as an audio file generated from a recorded call, or a transcript file generated from an audio file. The transcript file may be provided to selected recipients, similar to any other type of file. One of ordinary skill in the art will appreciate that the transcript file may be encrypted using any type of encryption means to restrict access to the transcript file. In one aspect, the call participant that initiated the recording may select one or more recipients for the transcript, including him or herself. A recipient list may be generated from a participant's contact list, such as e-mail contacts, social media contacts, or other list of contacts. One of ordinary skill in the art will appreciate that recipients may be selected in many different ways, and by any individual or entity.

In a preferred embodiment, the recording unit 233 is a hardware component installed in communications device 200, while the transcription unit is preferably a software module configured to convert an audio file generated by the recording unit into a transcript. However, one of ordinary skill in the art will appreciate that the recording unit and transcription unit may both be hardware, software, or a combination of hardware and software. As previously mentioned, the recording unit 233 may include VAD software for detecting voice activity on a call.

Furthermore, the recording unit may be configured to announce that a call is being recorded and request that each participant consent, either expressly or impliedly, to the recording. Expressed consent may be provided by typing one or more designated keys on a keypad or touchscreen. Alternatively, consent may be given by providing voice authorization, or sending a text message. A user may similarly decline to be recorded by entering one or more designated keys, providing a voice instruction, or a text message.

According to an embodiment of the invention, the recording unit may also be configured to provide a warning that that a maximum recording time is approaching. For example, the recording unit may interrupt a call to announce that there is 5 minutes of recording time remaining In another embodiment, the recording unit may provide a menu for one or more participants to order a transcript. The menu is preferably provided at the beginning or the end of a recorded call. However, the menu may be provided before, during, or at the end of a call. Further, the menu may be transmitted as a webpage, or other graphical user interface, or as an audio menu prompting the participants to select an option. An option may be selected by any known methods including, pressing one or more buttons, sending a text message, selecting one or more check boxes or radio buttons, typing a word or phrase, providing a voice command, or any other method known in the art.

According to an embodiment of the invention, the transcription unit is configured to retrieve an audio file generated by the recording unit 233 and convert it into a transcript that identifies each speaker and their associated speech. In one embodiment, each participant is identified by parsing homogenous speech segments according to sound wave patterns. Each speech segment is accorded a time stamp, so that the collective speech segments can be integrated into a transcript in the right sequence and time stamps can be placed next to each speaker's name to indicate the date/time they were speaking The transcription unit may be programmed to automatically generate a transcript for every audio file generated from a recorded call, or a menu option may be provided to allow a user to select whether to transcribe a recorded call. A user may also be able to browse audio files in a directory and select which files to transcribe.

The transcription unit may also include a speech recognition engine, such as ASR. The speech recognition engine converts the recorded audio file to text and stores the text as a text file. The text file may then be formatted into a preferred format, such as a legal transcript, business transcript, interview transcript, meeting minutes, or other desired format. One of ordinary skill in the art will appreciate that there are numerous formats that may be utilized and embodiments of the present invention are contemplated for use with any appropriate format. The transcript may be displayed on a display device, or printed in various formats such as portable document format (PDF), plain text, or word processor format such as Microsoft Word®.

In addition, ASR algorithms are available for different languages. In multilingual environments, the language for a given call or an individual audio connection can be specified, and language-specific ASR settings applied. Similarly, a transcript may be generated in different languages.

According to another aspect of the invention, the transcript may be subjected to a certification process in which the transcript is certified as an accurate representation of the conversation conducted during the call. The transcript and other pertinent data about the call may be provided to a third-party authentication service for review and certification, or an automated certification system may be used to certify the transcript. When the transcript is certified a certification stamp and/or date stamp may be printed on the transcript. The date stamp provides a verified record of the date, time and duration of the call.

In a preferred embodiment of the invention, a computer program is provided that is configured to generate a graphical user interface (GUI) for initiating a recorded call. More specifically, the computer program of the invention includes an interface module configured to generate a front end user interface that provides, among other things, options for recording and transcribing a voice call. The program further includes a control module for controlling a switch that activates/deactivates the recording unit. In this aspect of the invention, the control module activates the recording unit when a user selects a record option using the interface. The recording may be stopped when a user selects a stop recording option provided by the interface, or restarted again by selecting the record. The start and stop recording options may be the same button or different buttons. In other words, a user may select the start option to start recording and select it again to stop recording. One of ordinary skill in the art will further recognize that the start and stop options may be virtual buttons or icons, such as a button object on a touch screen, or physical keys/buttons on the device that transmit a signal to start/stop recording. Recording may also be terminated when the program receives a signal indicating that a call has been disconnected.

Once the recording is completed, the recorded call is saved as an audio file. A call transcription module transcribes the recording into a text file or transcript. One of ordinary skill in the art will recognize that the transcription module may be configured to transcribe the call in real time as described in U.S. Patent Application No. 2007/0088547 (Phonetic Speech-to-Text-to-Speech System and Method, published Apr. 19, 2007) or U.S. Patent Application No. 2004/0083105 (System and Method for Secure Real-Time High Accuracy Speech to Text Conversion of General Quality Speech, published Apr. 29, 2004), both of which are incorporated herein by reference in their entirety. Alternatively, the transcription module may transcribe the audio file after the call is recorded. The transcription module may incorporate features and functionality necessary to perform its speech to text transcription operation, such as those described in U.S. Pat. No. 5,752,227 to Lyberg (Method and Arrangement for Speech to Text Conversion, issued May 12, 1998) or U.S. Pat. No. 8,583,431 (Communications System with Speech-to-Text Conversion and Associated Methods, issued Nov. 12, 2013), both of which are incorporated herein by reference in their entirety.

Once the audio file and transcript are generated, the program provides a user with options for manipulating the audio file. These options include, but are not limited to, (1) listening to the recording; (2) adding audio notes to the recording; (3) displaying the text transcript; (4) playing/pausing/fast-forwarding/rewinding the audio file; (5) downloading the text transcript with or without a certification stamp; (6) transmitting the text transcript to one or more selected recipients; (7) providing the audio file to a third party authentication service for review to create a certified transcript that can be downloaded, emailed, or otherwise transmitted to selected recipients. One of ordinary skill in the art will appreciate that any electronic transmission service available may be used to transmit the files discussed herein including e-mail, text message, short messaging service (SMS), multimedia messaging service (MMS), instant messaging, point-to-point (P2P), point-to-multipoint (P2M). Furthermore, the above-described options may be provided via the front end user interface described above.

The computer program of the preferred embodiment may be a downloadable application or plug-in for any desired computing device capable of running the program, such as, for example, an Android® device, an iPhone®, a BlackBerry®, a desktop, a laptop, or other mobile device using any operating system (e.g. Windows®, Mac OS®, Linux®, etc.). Furthermore, the computer program may be comprised of one or more modules, classes, methods, functions, and data necessary to accomplish the operations described herein.

According to another aspect of the invention, real time transcription of a call may be accomplished by setting up a call through a third party service provider. The third party service provider may contact all of the parties to be called and inform the parties that the call is being recorded and/or transcribed. A live person will then perform functions similar to a court reporter by asking each party to identify themselves. Requested identification information may include full name, address, phone number, job title, etc. The live person transcribing the call will then record and/or transcribe the call in real time. In this embodiment, the computer program of the invention may include a fee tracking module that times the call and automatically bills a customer (i.e. the customer that ordered the transcription service) for the recording and/or transcribing the call. For example the transcription service may charge $2.00 per minute to transcribe a call. Therefore, if a call lasts five minutes, the customer would be charged $10.00. One of ordinary skill in the art will appreciate that many different billing methods may be employed in this embodiment, including billing based on quantity of information transcribed as opposed to time consumed. Once the call is completed and/or the transcript is generated, the funds can be deposited or transferred to an account owned by the third party provider.

According to another embodiment, the third party service provider uses its own billing method or software to bill for the recording and/or transcription service. In this embodiment, the third party service may use an API provided by the computer program of the present invention to incorporate its billing system into the user interface module. A user can then use the interface to keep track of billing while a call is being transcribed. For example, a virtual meter object may be displayed on the interface to show billing during the call.

In an alternative embodiment, an automated transcription service may be used instead of a live person. The automated service automatically records and/or transcribes a voice call and performs the same functions as the live transcription service described above. The automated transcription service may be integrated into the computer program in the form of a transcription module as previously described, or may be a component of the third party service provider.

According to another aspect of the invention, non-real time transcription services may be provided by a third party service provider. In this embodiment, the audio file generated by the recording unit is provided electronically to the third party service provider to generate a certified transcript from the recording. In this embodiment, the third party provider serves as a back end transcript generator instead of the transcription module previously described. The audio file may be securely provided to the third party service using any available method, including: providing secure access to a cloud based folder/directory containing the audio file; using a file transfer protocol (ftp); or sending the file in an email. For security purposes, the audio file may be encrypted using any known encryption means, and may include a hash key for accessing the file.

The computer program of the invention may also include a transmission unit configured to transmit the audio file and other relevant call data to the third party service. The other relevant data may include date, time and duration of the call, called phone numbers, identities of called parties, and actual participants in the call. According to one aspect, the transmission unit automatically transmits the audio file to a designated third party service provider. In another option, the user decides whether and when to send an audio file to a third party service for the purpose of generating an official transcript. In one exemplary embodiment, the user may use the interface to select a participating third party service provider from among a plurality of service providers and select a menu option to send the audio file to the selected third party service provider. The third party service then transcribes the audio file into an official certified transcript, which includes verified identities of called parties and participants to the call, and an official date stamp. The certified transcript with data stamp may be generated using a system and method such as the one described in U.S. Pat. No. 8,374,930 to Benisti et al. (Certified Email System and Method, issued Feb. 12, 2013), which is incorporated herein by reference in its entirety.

According to another aspect, a text file generated by the transcription unit or module, rather than the audio file, is provided to the third party service to generate an official certified transcript. Just as in the case where the audio file is provided, the third party service verifies the identities of called parties and call participants, and provides an official data stamp that verifies date, time, and duration of the call. The certification and date stamping of the transcript and/or audio file described herein may be accomplished by using a system such as the one described in U.S. Pat. No. 8,374,930 to Benisti et al.

The computer program of the preferred embodiment may also include an application programming interface (API) through which a third party service provider can display pricing information for its respective transcription service, along with shopping cart or order functionality. More specifically, the user interface generated by the interface module may be configured to receive and display pricing information from a third party service provider. A user can thus place an order for a certified transcript with a third-party service provider directly through the user interface. According to another option, a user may call the third party service provider or access a third party service provider website to place an order for a certified transcript.

According to an embodiment of the invention, the third-party service provider may transmit the completed official date stamped transcript to one or more selected recipients. In an exemplary embodiment, a user may select one or more recipients to receive an official transcript, including him or herself. A recipient list may be generated from a user's contact list, such as e-mail contacts, social media contacts, or other list of contacts. Alternatively, recipients may be selected by a third party, such as an employer, legal counsel, or government agent. In this case, remote access to the interface may be provided to the third party allowing them to order transcripts for one or more recipients.

The third party service provider is preferably an entity officially sanctioned or licensed to certify transcripts for use in legal proceedings. One of ordinary skill in the art will recognize, that such a third party service provider may have specific requirements in order to properly certify a recorded call. For example, the third party service provider may require that the call be transcribed in real time by a live person to ensure that the parties, date, time and duration of the call can be verified. Therefore, the system and method described herein may be configured to satisfy the specific requirements of a third party service provider to ensure that the transcript is properly certified.

Turning to the figures, according to the embodiment shown in FIG. 2 the recording unit and transcription unit may be installed in a communications device, such as smart phone, or other wireless communications device. Alternatively, these components may be distributed across multiple devices on a network. In a distributed configuration, each component is able to communicate with the other components via the network.

In an exemplary embodiment, a communications device is equipped with a touch key, switch, or button programmed to initiate a recording of a voice call. Alternatively, the communications device may include a touch screen option to initiate a recording, or may be voice activated. In a preferred embodiment, a recording is not initiated until a call is connected. A recording can be terminated by the participant that initiated the recording at any time during the call. Furthermore, a recording is terminated when the call is terminated.

During a recorded call, the VAD determines when a given participant is, and is not, speaking. In one aspect, the VAD can be very simple, detecting, for example, just that the audio signal exceeds a certain energy threshold. Or, in other aspects, the VAD can be more complex, distinguishing actual speech from other noises such as blowing wind, or coughing or breathing or typing. In various configurations, the VAD can also include, or work cooperatively with, a noise filter that removes the impairments before the audio signal is passed on. The sophistication of the VAD can have an impact on the quality of the transcription; however, embodiments of the invention are operable with a wide range of VAD algorithms, from simple to extremely complex.

According to an embodiment of the invention, an identifier may be used to identify each participant on a call. The identifier can be, for example, a numeric label; it could also be a “Caller-ID” captured as part of an incoming call or other signaling information sent when the call is established. Or, it could be communicated explicitly by a control function associated with the recording unit.

In some instances, the name of a voice call participant may be known to the recording system, and this can be associated with the speech output for that participant by printing the participant's name in the transcript in connection with their speech output. In some situations, there may be multiple individuals associated with a given audio connection, for example, when several people are in a single conference room sharing a speakerphone. Their speech can be tagged with a suitable label (“Boston Conference Room”), or a more explicit technique can be used to identify them. Or, the ASR could be taught to recognize a particular phrase (e.g. “Now speaking: Ralph”) that participants would use to introduce themselves, and the transcribed name could then be used to identify the speaker in the transcript. In addition, if a party declines to be recorded, the recording unit can insert a code that is interpreted by the transcription unit as a refusal to be recorded. For example, the transcript generated by the transcription unit could indicate that “John Doe was called on Date/Time and declined to participate in the call or be recorded.”

It can be seen that embodiments of the invention can operate when there is only one party to the call. Embodiments of the invention can also function when there are an unlimited number of parties to the call.

In another embodiment, a method is provided in which a user initiates a recorded call using a third party service 400. Prior to setting up a call with other parties the third-party service identifies all parties to be called 410. The identities of the parties may be determined by asking the user ordering the transcribed call to identify all parties to be called. This can be accomplished during a pre-call registration process in which the third party service gathers information about the call, such as date/time of the call, parties to be called and their contact information, expected duration, subject of the call, etc. The third party service next tries to set up a call by contacting the parties 420. The third party service may authenticate parties by asking them to verify their names, or other identifying information. A party authentication report may then be generated 412, which provides authentication information about the identities of the called parties.

If a call is refused 440, the third party system notes the refusal and reports it in the transcript 480. If a call goes to voice mail 450, the call initiator can leave a message which is recorded by the third party service, and includes the date, time and length of the message. The recording is then saved in an audio file 470. Alternatively, the third party service may leave an automated message if a call goes to voice mail.

If a call is established with at least one other party, the third party service verifies the identity of the called party and announces that the call will be recorded 460. This allows called parties to provide expressed or implied consent for the recording of their conversation. The call is then recorded and an audio file of the recording is saved 470 in a data store. A transcript of the audio file is then generated 480 and a copy is provided to one or more selected recipients 490. One of ordinary skill will appreciate that secure access to the transcript may be provided using various security means, such as a password, token, hash keys, ip address verification, and other forms of encryption and user authentication.

Users can search for audio and/or transcript files using keywords or other database search tools, and then elect to have an electronic copy of the file provided to them with a certified transcript. In one embodiment, the transcript file includes an embedded audio file of the recorded call. For example, a PDF transcript documents may include an embedded audio file of the recorded call. In addition, the embedded file may include an official voicemail notary stamp that states the identities of the participants along with date, time and duration of the call. The third party service may provide authenticated transcript reports of each call, including the verified identities of the participants and date/time information.

According to an embodiment of the invention, the transcript may include different types of information. For example, a transcript may indicate one or more of the following: (1) participants to the call; (2) whether the participant was authenticated; (3) the phone number(s) or parties called; (4) the party who initiated the call (i.e. the call initiator); (5) the date/time of the call; (6) the duration of the call; and (7) the transcribed conversation.

In addition to transcribing live calls, the third party service can transcribe voicemail messages. For example, if a call initiator places a call to another person via the third party service, the call initiator can leave a voicemail message which is recorded and transcribed. In this case, the transcript document provides evidence of: (1) the phone number called; (2) the number of calls placed to the phone number; (3) the name of the call initiator; (4) the date/time of the call; (5) the duration of the voicemail message; and (6) a transcript of the voicemail message.

In a scenario where a call is refused or recording of the call is refused, the third party service will not verify the refusing party. However, refusals may be reported in the transcript.

According to another embodiment, the system may also include dedicated inbound calls. In this embodiment, all calls are filtered through a third-party provider that records and verifies every call. Alternatively, a main number is provided that people call and are routed to the right person, such as a call directory where a caller can connect to a party by entering the first 3 digits of the party's last name. If it's a central number, the caller could also enter a PIN or press “0” to be connected to a live person to route the call through the system.

One will appreciate that the system described herein may have many useful applications, including, but not limited to: (1) providing evidence in a legal proceeding; (2) providing a record of a telephone meeting; (3) providing a record of a brainstorming session; (4) providing a record of an agreement between parties; and (5) providing a record of a transaction. Other useful applications and benefits will undoubtedly be discovered through use of the method and system of the invention, all of which should be considered natural extensions of the benefits described herein.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise teleconference bridges, set top boxes, programmable consumer electronics, communications devices, network PCs, minicomputers, mainframe computers, distributed computing environments that comprise any of the above systems or devices, and the like.

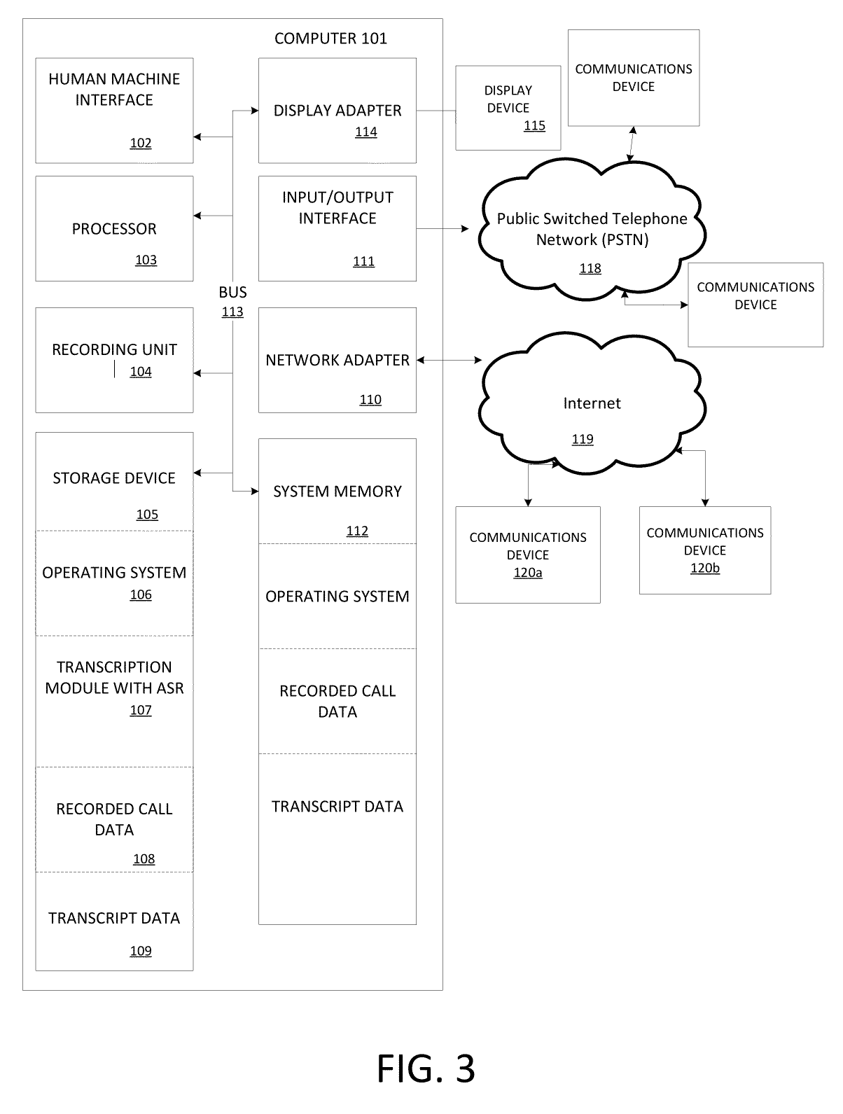

The system has been described above as comprised of units. One skilled in the art will appreciate that this is a functional description and that the respective functions can be performed by software, hardware, or a combination of software and hardware. A unit can be software, hardware, or a combination of software and hardware. In one exemplary aspect, the system can comprise a special purpose computer 101 as illustrated in FIG. 3 and described below.

The processing of the disclosed methods and systems can be performed by software components. The disclosed systems and methods can be described in the general context of computer executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a special-purpose computing device in the form of a programmed computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a recording unit with VAD software 104, a mass storage device 105, an operating system 106, a transcription unit with ASR software 107, recorded call data 108, transcript data 109, a network adapter 110, system memory 112, an Input/Output Interface 111, a display adapter 114, a display device 115, and a human machine interface 102, can be contained within one or more communications devices 120a,b at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as recorded call data 108, transcript data 109 and/or program modules such as operating system 106 and a Transcription module with ASR mechanisms software that are immediately accessible to and/or are presently operated on by the processing unit 103.

In another aspect, the computer 101 can also comprise other removable/non-removable, volatile/non-volatile computer storage media. By way of example, FIG. 3 illustrates a mass storage device 105 which can provide non-volatile storage of computer code, computer readable instructions, data structures, program modules, and other data for the computer 101. For example and not meant to be limiting, a mass storage device 105 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 105, including by way of example, an operating system 106 and transcription module with ASR 107. Recorded call data 108 can also be stored on the mass storage device 105. Recorded call data 108 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

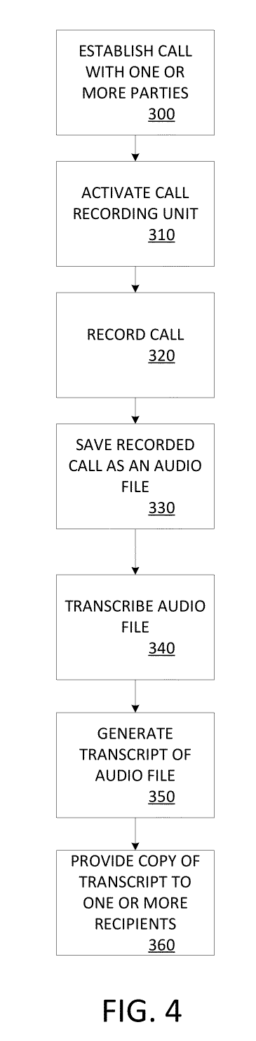

In yet another aspect, a display device 115 can also be connected to the system bus 113 via an interface, such as a display adapter 114. It is contemplated that the computer 101 can have more than one display adapter 114 and the computer 101 can have more than one display device 115. For example, a display device can be a monitor, an LCD (Liquid Crystal Display), or a projector. In addition to the display device 115, other output peripheral devices can comprise components such as speakers (not shown) and a printer (not shown) which can be connected to the computer 101 via Input/Output Interface 111. Any step and/or result of the methods can be output in any form to an output device. Such output can be any form of visual representation, including, but not limited to, textual, graphical, animation, audio, tactile, and the like. Furthermore, in one embodiment, the computer 101 can be operably connected with a public switched telephone network (PSTN) 118, as shown in FIGS. 1 and 4, providing connection to endpoint devices 210, 212.

The computer 101 can operate in a networked environment using logical connections to one or more communications devices 120a,b and endpoint devices 210, 212. By way of example, a communications device can be a personal computer, portable computer, a server, a router, a network computer, a peer device or other common network node, a teleconference bridge, endpoint devices 210, 212 as shown in FIG. 1, and so on. Logical connections between the computer 101 and a communications device 120a, b can be made via a local area network (LAN) and a general wide area network (WAN), or specialized networks such as a PSTN 118. Such network connections can be through a network adapter 110. A network adapter 110 can be implemented in both wired and wireless environments. Such networking environments are conventional and commonplace in offices, enterprise-wide computer networks, intranets, and the Internet 119.

For purposes of illustration, application programs and other executable program components such as the operating system 106 are illustrated herein as discrete blocks, although it is recognized that such programs and components reside at various times in different storage components of the computing device 101, and are executed by the data processor(s) of the computer. An implementation of VAD and ASR can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage, or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

### Exemplary Method of Use:

The following example is put forth so as to provide those of ordinary skill in the art with a complete disclosure and description of how the systems, devices and/or methods described herein are made and evaluated, and are intended to be purely exemplary and are not intended to limit the scope of the methods and systems.

Referring to the exemplary flowchart of FIG. 4, a process is illustrated for practicing an aspect according to an embodiment of the present invention. At step 300 a call is established among one or more participants. At step 310, the recording unit is activated and at step 320 recording begins. As previously discussed, the recording unit may be configured to start detecting audio communications using the Voice Activity Detector (VAD). However, in another embodiment, the recording unit starts recording as soon as it is activated by a user and records any audio detected during the call. Recording ends when the user who initiated the recording presses the record button again, selects an off button, or if the call is ended. In yet another embodiment, the recording unit starts recording after each participant provides their consent to the recording, for example, by pressing one or more keys, providing voice authorization, or entering a word or phrase. One of ordinary skill in the art will appreciate that there are many ways to provide consent to record a call. At step 330, the recorded call is saved as an audio file. At step 340, the transcription unit transcribes the audio file. The transcription unit may include ASR, which assigns an identifier to each participant and a time sequence position. At step 350, a transcript is generated by the transcription unit where each participant's dialogue is associated with a corresponding participant ID and sequence position. At step 360, the transcript is provided to one or more recipients. The recipients may be selected by the participant that initiated the recording, by a third party, or may be determined by a transcript subscription list. One of ordinary skill in the art will recognize that there are numerous ways to select recipients.

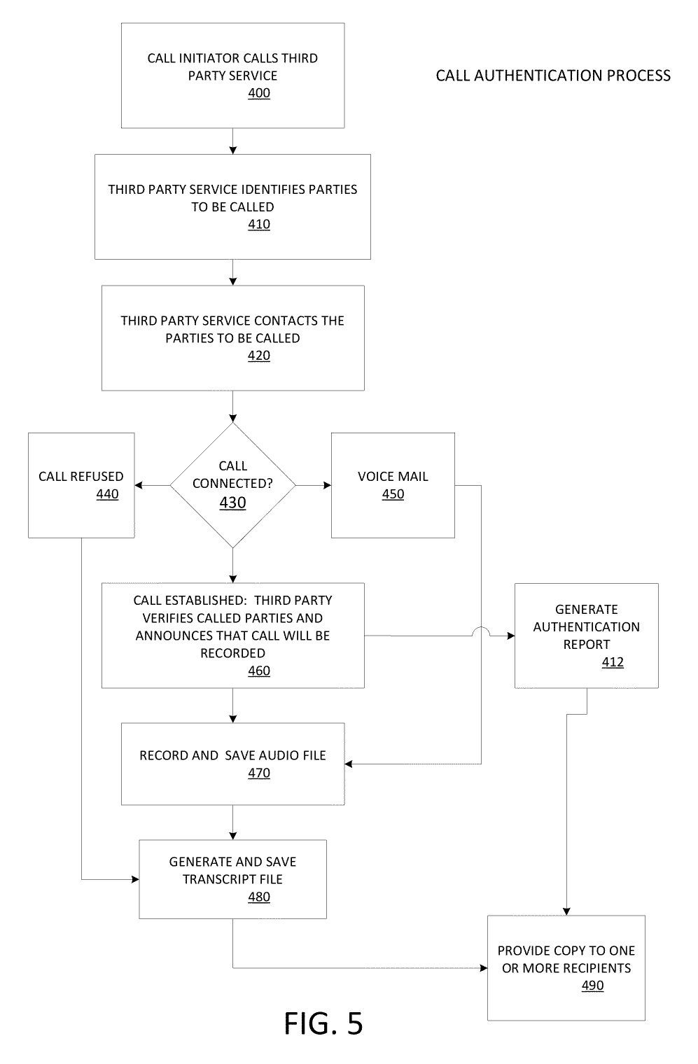

Referring to the exemplary flowchart of FIG. 5, a process is illustrated for practicing an aspect according to an embodiment of the present invention. At step 400 a call is initiated to a third party service that sets up recorded calls and transcribes the recording. One of ordinary skill in the art will appreciate that the third party service may be an automated third party service or a human operated third party service. At step 410 the third party service identifies parties to be called. This can be accomplished by querying the call initiator at the time the call is initiated, or during a call registration process that takes place before the call is initiated. For example, to set up a recorded/transcribed call the call initiator may have to register with the third party through a website. Once registration is complete the call initiator may receive a unique username, PIN, password, token, or other security information via text, voicemail or email. The call initiator then uses the PIN to log into the third party service website portal.

According to one embodiment, whenever a call initiator wishes to initiate a call they would provide their PIN or password to the third party service, so that the call initiator's identity can be authenticated. Alternatively, the call initiator may be required to log into a third party service website portal and provide information about a call each time the call initiator wishes to initiate a call. For example, the third party service may request call information, including names of parties to be called, contact information for the parties to be called, other identifying information about parties to be called, the purpose of the call, the expected duration of the call, etc. Once the requested information is received and validated, the call initiator can initiate a call using the third party service.

At step 420, the third party service contacts the parties to be called. If the call is connected 430, but the called party refuses to participate 440, the refusal is reported when the transcript is generated 480. Otherwise, if the call goes to voicemail 450, the call initiator can record a message which is also recorded by the third party service and saved as an audio file 470. In addition, another party besides the call initiator may leave a message, including the third party service. A transcript of the message is subsequently generated at step 480.

At step 460 the third party service establishes a call with at least one other party. The third party is then able to verify the identity of the called party. Verification can be accomplished by asking the called party one or more questions, or asking the called party to enter or provide some identifying information such as their full name, address, zip code, date of birth, last four digits of their social security number, or some other identifying information. The third party service also announces to all parties that the call will be recorded. The announcement may be made before or after the called parties are verified. The called parties may then provide their expressed or implied consent to the recording by pressing a key, entering a code, providing voice authorization, or simply staying on the line and participating in the call.

At step 470 the call is recorded and saved as an audio file. At step 480 a transcript is generated from the audio file and saved as a separate file. However, the transcript may also be generated at the same time the call is being recorded. One or ordinary skill in the art will appreciate that there are many possible formats for saving the transcript, such as PDF, MS WORD™, html, xml, plain text, etc. At step 490 the transcript file is provided to one or more recipients. The transcript may be provided in a secure manner by making it password protected, or limiting access using other well-known security measures.

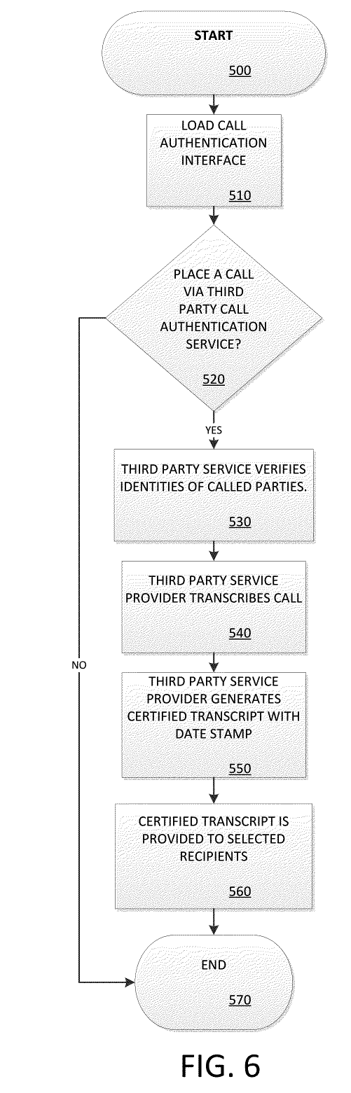

Referring to the exemplary flowchart of FIG. 6, a process is illustrated for practicing an aspect according to an embodiment of the present invention. At step 500, the call authentication program is initialized and the call authentication interface is loaded into memory 510. In general, the interface includes options for placing an authenticated call using a third party authentication service. The third party authentication service is preferably licensed to generate certified transcripts for use in legal proceedings. A user can then use the authentication interface to place a call via a third party call authentication service 520. Once the called parties are on the call, the third party service verifies their identities by asking them for identifying information, such as full name, address, phone number, job title, etc. The call is then transcribed by the third party service 540 and an official certified transcript is generated 550.

The certified transcript includes a date stamp which includes a verified date, time and duration of the call. The time further includes a start time and an end time. The certified transcript is then provided to selected recipients 560 and the process ends at 570.

In another aspect of the invention, the third party service may record voicemails from users and transmit notifications to selected recipients via text, voicemail, or email. The selected recipient receives instructions on where to call (i.e. a phone number), or a website address to access their secure voicemails. Once the user is authenticated by, for example, entering a username, password, PIN, or other authentication information, the voicemail message is played for the user. In addition, a printed transcript of the message is provided to the user.

An authenticated receipt may also be generated with a transcript of the message along with identification details of the person who “signed” for the message. The system is also configured to calculate the percentage of the message that was played before the user either clicked off the website or hung up the phone.

One will appreciate that the transcripts and/or recordings generated by the system and method described herein may have many useful applications, including, but not limited to providing: (1) evidence in a legal proceeding; (2) a record of a telephone meeting; (3) a record of a brainstorming session; (4) a record of an agreement between parties; (5) a record of a transaction; (6) a record of a negotiation. In addition, the system and method described herein may be used in numerous contexts, including, but not limited to: (1) divorce negotiations; (2) business negotiations; (3) bank loan modification calls; (4) requesting extensions in a legal action such as a landlord tenant dispute; and (5) verbal contracts. Other useful applications and benefits will undoubtedly be discovered through use of the method and system of the invention, all of which should be considered natural extensions of and contemplated within the purview of the disclosed invention.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method inventive concept does not actually recite an order to be followed by its steps or it is not otherwise specifically stated in the inventive concepts or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

What is claimed:

1. A system for recording and transcribing a voice call, the system comprising:
a recording unit configured to record audio communications taking place on a communications device, and storing said recorded call as an audio file;
a transcription unit configured to retrieve said audio file and convert said file into a transcript that identifies each call participant and their associated dialogue in the correct sequence;
whereby a voice call may be selectively recorded and transcribed.

2. The system of claim 1, wherein said recording unit is installed in said communications device.

3. The system of claim 2, wherein said communications device comprises functionality for selectively recording a voice call and generating a transcript of the recorded call.

4. The system of claim 1, wherein said recording unit is a standalone device that operably connects to a communications device, to enable recording of a call placed using said communications device.

5. The system of claim 1, wherein said recording unit comprises a voice activity detector (VAD).

6. The system of claim 1, wherein said transcription unit comprises a speech recognition engine.

7. The system of claim 1, wherein the recording unit is configured to request consent from said participants before recording a call.

8. The system of claim 1, wherein the recording unit is configured to receive consent from said participants.

9. The system of claim 13, wherein said consent is recorded and printed in the transcript.

10. A method of authenticating a call comprising the steps of:
a. initiating a call to a third party service;
b. calling one or more identified parties via the third party service;
c. establishing a call with one or more called parties and verifying their identities via the third party service;
d. transcribing the call in real time via the third party service;
e. generating an official certified transcript of the recorded call and saving it as a transcript file via the third party service; and
f. providing a copy of the transcript to one or more recipients via the third party service.

11. The method of claim 10, further comprising the step of generating an authentication report listing verified called parties.

12. The method of claim 10, further comprising the step of recording the call and saving the recording as an audio file.

13. The method of claim 10, wherein the transcript includes a date stamp comprising a verified date, time and duration of the call.

14. The method of claim 10, wherein the transcript identifies each called party by name.

15. The method of claim 10, wherein verification of each called party is accomplished by asking the called parties to provide identifying information.

16. The method of claim 10, wherein a call initiator must complete a registration process with the third party service before initiating a call.

17. The method of claim 16, wherein said registration process includes providing identifying information for the call initiator.

18. The method of claim 17, wherein said registration process includes providing call information comprising: call purpose, parties to be called, contact information for parties to be called, identifying information for parties to be called, and expected duration of the call.

19. The method of claim 10, wherein said audio file and transcript file are searchable.

20. The method of claim 10, wherein said transcript is a certified report.

21. The method of claim 12, wherein said audio file is embedded in said transcript file.

22. The method of claim of claim 10, wherein an official voicemail notary stamp is embedded in said transcript.

23. The method of claim 22, wherein said voicemail notary stamp identifies the called parties that participated in the call, provides authentication information about said parties, and provides date, time and duration of the call.

24. The method of claim 10, wherein the transcript comprises:
verified identities of one or more called parties,
number of times a call was placed to each party and the phone number called,
name of the party that initiated the call,
name of each called party that participated in the call,
the date and time of the call,
the duration of the call, and
a transcribed conversation of the call.

25. The method of claim 24, wherein said transcript further comprises a transcribed voicemail message left for a called party.

26. The method of claim 24, wherein said transcript further comprises a notation that a call to one or more called parties was refused.

27. The method of claim 26, wherein said notation comprises the name of said refusing called party, the date of the call, the time of the call, and the duration of the call.

28. The method of claim 10, wherein a user's incoming calls can be routed through said third party service, whereby each incoming call is recorded and transcribed by said third party service.
